(19) United States
(12) Patent Application Publication
(10) Pub. No.: US 2013/0262224 A1
(43) Pub. Date: Oct. 3, 2013

(54) Providing More Relevant Ads to Motorists

(71) Applicant: Peter Zhe Chu, Santa Clara, CA (US)

(72) Inventor: Peter Zhe Chu, Santa Clara, CA (US)

(73) Assignee: eBay Inc., San Jose, CA (US)

(21) Appl. No.: 13/435,144

(22) Filed: Mar. 30, 2012

(51) Int. Cl. G06Q 30/02

(52) U.S. Cl. 705/14.53; 705/14.66

(57) ABSTRACT

The present disclosure involves a method of communicating relevant messages that includes: obtaining information from a motorist in a vehicle; generating one or more advertising offers relevant to the motorist based on the obtained information; and communicating the one or more advertising offers to the motorist. The present disclosure also involves a method of advertising that includes: receiving data gathered from a transportation tool; determining, in response to the data gathered from the transportation tool, information that is relevant to an operator of the transportation tool; and conveying the information to the operator through a communications device in the transportation tool.

### BACKGROUND

1. Technical Field

The present disclosure generally relates to a method of advertising, and more particularly, to providing more relevant ads to motorists.

2. Related Art

Advertisements (or ads) are communicated to prospective buyers through various types of media. For example, televisions, radios, magazines, newspapers, brochures, the Internet (accessibly by a computer), or even word of mouth have all been used as advertising media. For motorists, however, ads have typically been communicated to them either through a radio in a vehicle that the motorist is operating, or through billboards located on the side of the roads. The passive nature of such communication (i.e., the user did not request these ads) usually results in ineffective advertising. In other words, the motorist is unlikely to be interested in the majority of the ads he has heard on the radio or seen on the roadside billboards, since most of these ads have low relevance to him.

Therefore, while methods of advertising to motorists have been generally adequate for their intended purposes, they have not been entirely satisfactory in all respects. It would be advantageous to provide more relevant ads to motorists so as to improve the effectiveness of the ads.

### SUMMARY

One of the broader forms of the present disclosure involves a method of communicating relevant messages. The method involves: obtaining information about a motorist in a vehicle; generating one or more advertising offers relevant to the motorist based on the obtained information; and communicating the one or more advertising offers to the motorist.

Another one of the broader forms of the present disclosure involves an apparatus comprising a non-transitory, tangible computer readable storage medium storing a computer program. The computer program has instructions that when executed, perform: obtaining information from a motorist in a vehicle; generating one or more advertising offers relevant to the motorist based on the obtained information; and communicating the one or more advertising offers to the motorist.

Yet another one of the broader forms of the present disclosure involves a method of advertising. The method involves: receiving data gathered from a transportation tool;

determining, in response to the data gathered from the transportation tool, information that is relevant to an operator of the transportation tool; and conveying the information to the operator through a communications device in the transportation tool.

### BRIEF DESCRIPTION OF THE DRAWINGS

FIGS. 1-3 illustrate simplified diagrams of a motorist in a vehicle according to various aspects of the present disclosure.

FIG. 2 illustrates an example block diagram of a vehicle in communication with a server according to various aspects of the present disclosure.

FIG. 3 illustrates a flowchart containing process flows according to various aspects of the present disclosure.

FIG. 4 illustrates a block diagram of a computer system for implementing the various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

Conventional methods of advertising to a motorist in a vehicle have generally not been very effective. For example, advertising offers (or ads) may come in the form of radio ads or roadside billboards. Since the motorist has not requested these ads, the content of most of the ads is not very relevant to the motorists. As a result, the motorists are less likely to follow through with a purchase.

According to the various aspects of the present disclosure, discussed below are a method and apparatus for providing more relevant ads to a motorist.

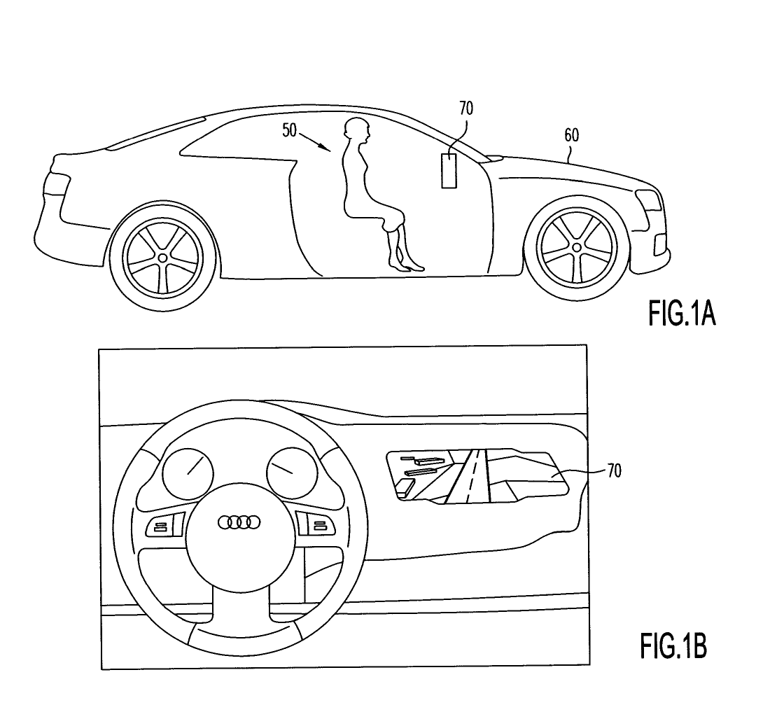

Referring to FIG. 1A, a simplified block diagram of a motorist 50 in a vehicle 60 is illustrated. The motorist 50 may be a person who is an owner of the vehicle, or may be an operator but not an owner of the vehicle, or may be a passenger in the vehicle. Though the vehicle 60 is shown as a car herein, it is understood that the vehicle may be a truck, a van, a sports utility vehicle (SUV), a bus, a train, an airplane, or any other suitable transportation tool.

An interactive communications device 70 is implemented inside the vehicle 60. A simplified diagram of the interactive communications device 70 is shown in FIG. 1B. The interactive communications device 70 is implemented to include a user interface, which may include a visual display and/or an audio input/output. The interactive communications device 70 has communications capabilities that allow it to communicate with external devices. For example, the interactive communications device 70 may include a wireless transceiver. An advanced mobile operating system (for example, GOOGLE's ANDROID operating system) may be installed on the interactive communications device 70 to govern its operations.

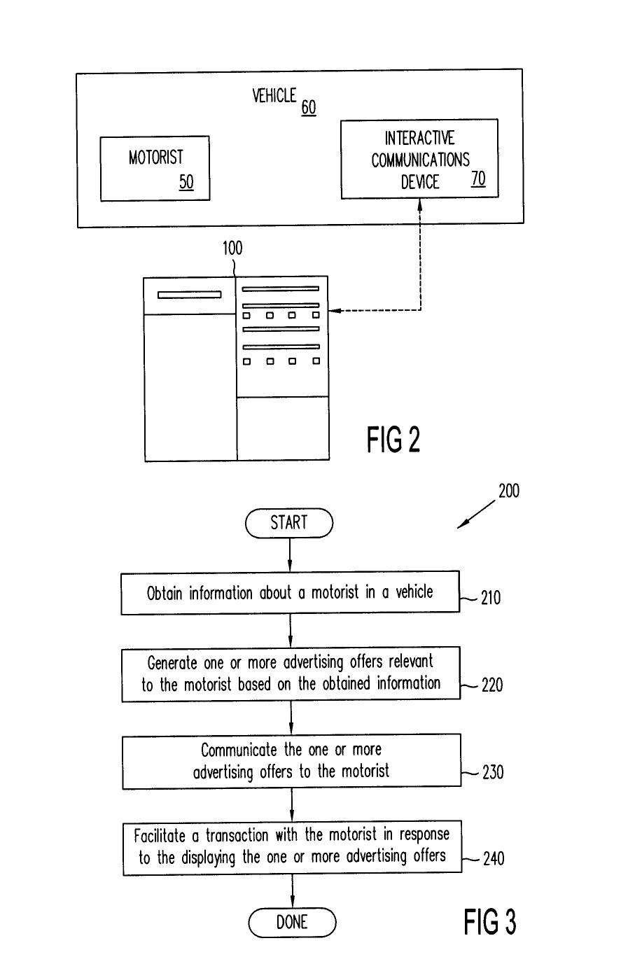

The interactive communications device 70 is operable to collect information (or data) from the motorist 60 and/or the vehicle 60 and send that information to an external entity for processing. This is illustrated in FIG. 2, which is a simplified block diagram of the vehicle 60 with the interactive communications device 70 implemented therein as well as an external server 100 that is communicatively coupled with the interactive communications device 70.

The interactive communications device 70 constantly monitors the status of the vehicle 60 and/or the motorist 50 and gathers relevant data from the vehicle 60 and/or the motorist 50. As an example, the interactive communications device 70 may include (or may be coupled to) a Global Positioning System (GPS) device. As such, the interactive communications device 70 can extract the GPS coordinates of the vehicle 60 at any given time. In some embodiments, buildings or other fixed land structures may also be used to determine the position of the vehicle 60. For example, these external structures may be implemented with wireless communications capabilities, and as such they may be able to ascertain the position of the vehicle 60 through communicating wirelessly with the interactive communications device 70.

As another example, the interactive communications device 70 can also calculate the speed or velocity at which the vehicle 60 is moving. This may be accomplished through the GPS device in the vehicle 60 or in the interactive communications device 70, or may be extracted through the speedometer of the vehicle 60. In cases where the motorist 50 has entered a target destination, the interactive communications device 70 can extract this information, as well as a planned route that the vehicle 60 will travel to reach the target destination. Furthermore, in some cases the motorist 50 may also be able to save his or her identity into the interactive communications device 70. The identity of the motorist 50 may include elements such as: a list of places visited by the motorist 50, a list of searches conducted by the motorist 50, a list of merchandise purchased by the motorist 50, driving preferences of the motorist 50 (e.g., avoid toll roads, avoid highways, take the quickest route), etc. Other examples of data that can be gathered from the vehicle 60 or the motorist 50 may include the time of the day, the age and gender of the motorist, the condition of the vehicle, etc.

As the vehicle 60 is moving, the various pieces of information associated with the motorist 50 or the vehicle 60 are collected and stored by the interactive communications device 70. The interactive communications device 70 then sends the information to the server 100. In the context illustrated in FIG. 2, the server 100 may belong to a “demand generation” entity. In general, “demand generation” refers to marketing tactics or programs that enhance awareness and interest in a company's services or products. When implemented well, demand generation can help match more relevant offers to interested consumers. Here, the server 100 communicates with a plurality of merchants or service providers to find out what products and services they would like to advertise, and what types of offers are available for these products and services. These offers and ads, as well as other merchant information, may be stored in an electronic database inside the server 100, or in a database accessible by the server 100.

The server 100 also receives the information sent by the interactive communications device 70, for example through a wireless transceiver. In other words, the server 100 itself may contain a wireless transceiver or may be coupled to another wireless transceiver that can communicate wirelessly with the interactive communications device 70. Once the information gathered by the interactive communications device 70 is obtained by the server 100, the server 100 processes the gathered information to determine which potential offers from the above mentioned merchants and service providers are relevant to the motorist 50. The server 100 may thereafter generate one or more offers or ads that are relevant to the motorist 50.

As an example, the information collected by the interactive communications device 70 indicates that the motorist has visited a number of fast food restaurants in the past week or month. Based on this information, the server 100 may determine that the motorist 50 enjoys fast food and may wish to be apprised of any available offers from fast food restaurants. Therefore, the server 100 can instruct the interactive communications device 70 to visually display a coupon for a combo meal at a specific fast food restaurant to the motorist 50. Alternatively, the server 100 may also instruct the interactive communications device 70 to audibly announce the offer to the motorist, for example through the audio device of the interactive communications device 70 or through the speakers of the vehicle 60.

If a location of the vehicle 60 is known (e.g., as a part of the gathered information), the server 100 may be able to advertise an offer from a fast food restaurant that is geographically close to the vehicle 60, so as to enhance the offer's relevance and to increase the likelihood of the motorist 50 following through with a purchase.

Furthermore, if the target destination of the motorist 50 is also obtained, the server 100 may advertise a coupon (or any other offer) from a fast food restaurant at or close to the destination. If the motorist 50 accepts the offer, he may be allowed to pay for his meal in advance. When the motorist 50 reaches the fast food restaurant at or near the target destination, he can simply go pick up his meal that he has already paid for, without having to wait in line to pay for it. Consequently, the transactional process is simplified, which makes it more convenient for the motorist to engage in the transaction. In other words, the offers or ads become more relevant to the motorist since they are more likely to be accepted. Thus, the embodiments of the present disclosure allow personalized ads or offers to be communicated to a motorist.

As another example, the information gathered from the vehicle 60 may indicate that the gas tank in the vehicle is running on low. The server 100 may analyze this piece of information and determine that the motorist 50 is likely to need a gas fill-up very soon. The server 100 may then scan its electronic database to see what gas stations are located nearby to the motorist/vehicle. The server 100 then instructs the interactive communications device 70 to communicate ads from the nearby gas stations to the motorist 50. If any of the nearby gas stations are offering promotions or deals, they may be communicated to the motorist 50 as well. Since the motorist 50 likely needs a gas refill, he will consider these ads relevant and may very well follow through with a purchase.

In situations where the motorist 50 has accepted an offer and is willing to go through with a purchase, the server 100 may also be configured to facilitate the purchasing transaction. For example, the server 100 may work with a third party payment provider such PAYPAL, INC S. of San Jose, Calif. or another suitable financial institution to transfer funds from the motorist's account to a merchant.

Though the server 100 may communicate ads or offers for commercially available products and services to the user—as discussed in the examples above—other useful or relevant messages may also be communicated to the motorist 50 based on the data obtained from the motorist 50 or vehicle 60. For example, in cases where the target destination of the motorist 50 is obtained, the server 100 may retrieve pertinent travel-related information such as the current weather and the forecasted weather at the destination or the traffic conditions along the route. Such information is relevant and useful to the motorist 50 even though no purchases are involved. As another example, the motorist 50 may have previously entered a “to-do” list in the interactive communications device 70. One task on the to-do list is picking up groceries. Based on the location of the vehicle 60, the server 100 may determine that the vehicle 60 is close to a grocery store. Therefore, the server 100 may notify the motorist 50 through the interactive communications devices 70 that he can complete his grocery shopping at the nearby grocery store.

It is also understood that the relevant offers/ads/other relevant messages need not necessarily be communicated to the motorist 50 through the interactive communications device 70. Devices external to the vehicle, such as electronic billboards may also be used to communicate the offers/ads/other relevant messages. In some embodiments, data may be extracted from a group of motorists and vehicles. The data may be collectively analyzed by the server 100 together, and the server 100 may communicate relevant messages to the motorists as a group based on the collectively analysis.

FIG. 3 is a flowchart illustrating a method 200 of communicating relevant messages according to various aspects of the present disclosure. The method 200 includes a block 210 in which information is obtained about a motorist in a vehicle. The information may be obtained through a communications device in the vehicle. In some embodiments, the information includes at least one of the following: a position of the vehicle, a speed of the vehicle, a destination of the vehicle, a planned route to the destination, and an identity of the motorist. The identity of the user may include previous shopping history of the motorist. The information may be obtained from the vehicle while the vehicle is moving.

The method 200 includes a block 220 in which one or more advertising offers relevant to the motorist are generated based on the obtained information. In some embodiments, the offers are generated by matching a list of available offers with the likely needs of the motorist. The likely needs of the motorist may be determined based on the information obtained in the block 210. In some embodiments, the offers need not necessarily involve commercial purchases. In other words, the offers may be messages considered useful and relevant to the motorist but are not tied to particular merchandise.

The method 200 includes a block 230 in which the one or more advertising offers are communicated to the motorist. In some embodiments, the advertising offers are communicated by displaying the offers through a visual display in the vehicle. In some other embodiments, the advertising offers are communicated by audibly announcing the offers through a speaker in the vehicle. In yet other embodiments, the advertising offers are communicated by displaying the offers through a billboard outside the vehicle.

The method 200 includes a block 240 in which a transaction with the motorist is facilitated in response to the offers being displayed. It is understood that the method 200 may include additional steps that may be performed before, during, or after the blocks 210-240. For the sake of simplicity, these additional steps are not discussed in detail herein.

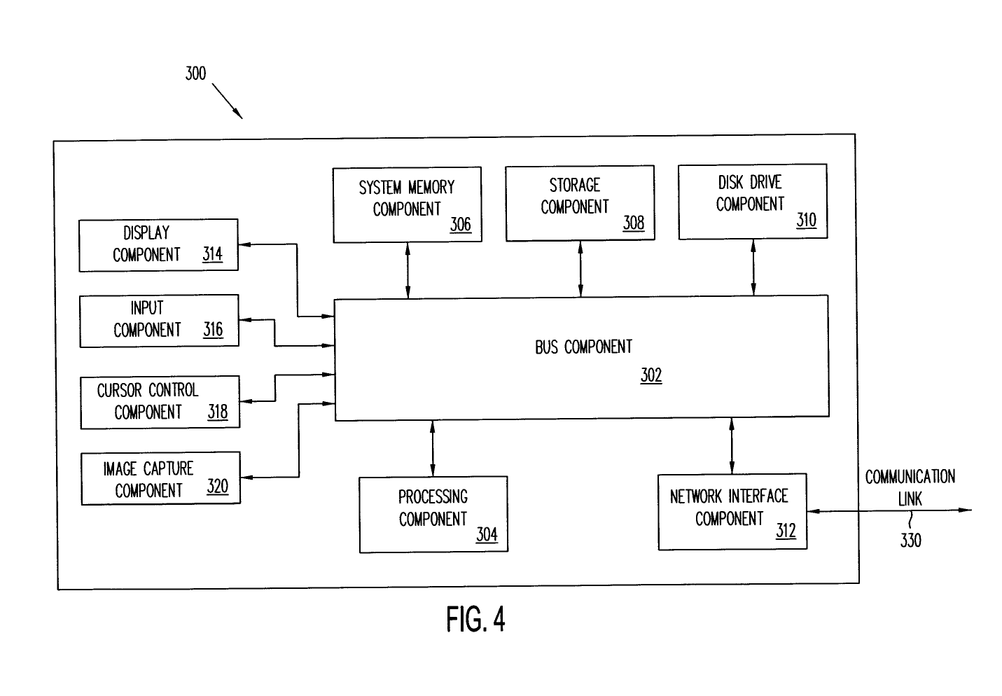

FIG. 4 is a block diagram of a computer system 300 suitable for implementing the methods and devices described herein, such as to implement the various method blocks of the method 200. In certain embodiments, the computer system 300 may be used to implement the server 100 or the interactive communications device 70 (FIG. 2) described above, or portions thereof.

In various implementations, the computer system 300 may comprise a network communications device (e.g., mobile cellular phone, laptop, personal computer, tablet, etc.)

capable of communicating with a network. The computer system 300 may also comprise a network computing device (e.g., a network server, a computer processor, an electronic communications interface, etc).

In accordance with various embodiments of the present disclosure, the computer system 300, such as a mobile communications device and/or a network server, includes a bus component 302 or other communication mechanisms for communicating information, which interconnects subsystems and components, such as a processing component 304 (e.g., processor, micro-controller, digital signal processor (DSP), etc.), a system memory component 306 (e.g., RAM), a static storage component 308 (e.g., ROM), a disk drive component 310 (e.g., magnetic or optical), a network interface component 312 (e.g., modem or Ethernet card), a display component 314 (e.g., touch-screens, cathode ray tube (CRT) displays, or a liquid crystal display (LCD)), an input component 316 (e.g., keyboard or touch-sensitive components operable to detect a touch by a human body), a cursor control component 318 (e.g., mouse or trackball), and an image capture component 320 (e.g., analog or digital camera). In one implementation, the disk drive component 310 may comprise a database having one or more disk drive components.

In accordance with embodiments of the present disclosure, the computer system 300 performs specific operations by processor 304 executing one or more sequences of one or more instructions contained in the system memory component 306. Such instructions may be read into system memory component 306 from another computer readable medium, such as a static storage component 308 or a disk drive component 310. In other embodiments, hard-wired circuitry may be used in place of (or in combination with) software instructions to implement the present disclosure.

Logic may be encoded in a computer readable medium, which may refer to any medium that participates in providing instructions to processor 304 for execution. Such a medium may take many forms, including but not limited to, non-volatile media and volatile media. In one embodiment, the computer readable medium is non-transitory. In various implementations, non-volatile media includes optical or magnetic disks, such as disk drive component 310, and volatile media includes dynamic memory, such as system memory component 306. In one aspect, data and information related to execution instructions may be transmitted to the computer system 300 via a transmission media, such as in the form of acoustic or light waves, including those generated during radio wave and infrared data communications. In various implementations, transmission media may include coaxial cables, copper wire, and fiber optics, including wires that comprise bus 302.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 300. In various other embodiments of the present disclosure, a plurality of computer systems 300 coupled by a communication link 330 (e.g., a communications network, such as a LAN, WLAN, PTSN, and/or various other wired or wireless networks, including telecommunications, mobile, and cellular phone networks) may perform instruction sequences to practice the present disclosure in coordination with one another.

The computer system 300 may transmit and receive messages, data, information and instructions, including one or more programs (i.e., application code) through the communication link 330 and a communication interface 312. Received program code may be executed by the processor 304 as received and/or stored in the disk drive component 310 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of communicating relevant messages, comprising:
obtaining information about a motorist in a vehicle;
generating one or more advertising offers relevant to the motorist based on the obtained information; and
communicating the one or more advertising offers to the motorist.

2. The method of claim 1, wherein the communicating comprises displaying the one or more advertising offers through a visual display in the vehicle.

3. The method of claim 1, wherein the communicating comprises audibly announcing the one or more advertising offers through a speaker in the vehicle.

4. The method of claim 1, wherein the communicating comprises displaying the one or more advertising offers through a billboard outside the vehicle.

5. The method of claim 1, wherein the information comprises at least one of the following: a position of the vehicle, a speed of the vehicle, a destination of the vehicle, a planned route to the destination, and an identity of the motorist.

6. The method of claim 5, wherein the identity of the user comprises previous shopping history of the motorist.

7. The method of claim 1, further comprising: facilitating a transaction with the motorist in response to the displaying the one or more advertising offers.

8. The method of claim 1, wherein the obtaining the information is performed while the vehicle is moving.

9. An apparatus comprising a non-transitory, tangible machine-readable storage medium storing a computer program, wherein the computer program contains machine-readable instructions that when executed electronically by processors, perform:
obtaining information about a motorist in a vehicle;
generating one or more advertising offers relevant to the motorist based on the obtained information; and
communicating the one or more advertising offers to the motorist.

10. The apparatus of claim 9, wherein the instructions for the communicating comprise instructions for prompting a visual display in the vehicle to display the one or more advertising offers.

11. The apparatus of claim 9, wherein the instructions for the communicating comprise instructions for prompting a speaker in the vehicle to audibly announce the one or more advertising offers.

12. The apparatus of claim 9, wherein the instructions for the communicating comprise instructions for prompting a billboard outside the vehicle to display the one or more advertising offers.

13. The apparatus of claim 9, wherein the information comprises at least one of the following: a position of the vehicle, a speed of the vehicle, a destination of the vehicle, a planned route to the destination, and an identity of the motorist.

14. The apparatus of claim 13, wherein the identity of the user comprises previous shopping history of the motorist.

15. The apparatus of claim 9, further comprising: instructions for facilitating a transaction with the motorist in response to the displaying the one or more advertising offers.

16. A method of advertising, comprising:
receiving data gathered from a transportation tool;
determining, in response to the data gathered from the transportation tool, information that is relevant to an operator of the transportation tool; and
conveying the information to the operator through a communications device in the transportation tool.

17. The method of claim 16, wherein the communications device comprises a visual screen or an audible speaker.

18. The method of claim 16, wherein the data gathered from the transportation tool comprises data selected from the group consisting of: a location of the transportation tool, a velocity of the transportation tool, a destination of the transportation tool, a planned route for reaching the destination, and shopping history of the operator of the transportation tool.

19. The method of claim 16, wherein the receiving the data comprises receiving the data while the transportation tool is in transit.

20. The method of claim 16, wherein the conveying the information comprises reminding the operator of the transportation tool of a list of tasks.

21. The method of claim 16, wherein the conveying the information comprises advertising an offer to the operator of the transportation tool.

22. The method of claim 21, further comprising: facilitating a purchase based on the offer.
